(19) United States
(12) Patent Application Publication
(10) Pub. No.: US 2025/0203439 A1
(43) Pub. Date: Jun. 19, 2025

(54) AUGMENTED MESSAGES FOR BACKSCATTER DEVICES

(71) Applicant: Cisco Technology, Inc., San Jose, CA (US)

(72) Inventors: Domenico FICARA, Essertines-Sur-Yverdon (CH); Ugo M. CAMPIGLIO, Morges (CH); Indermeet S. GANDHI, San Jose, CA (US); Jerome HENRY, Pittsboro, NC (US); Amine CHOUKIR, Ecublens (CH); Robert E. BARTON, Richmond (CA)

(21) Appl. No.: 18/797,374

(22) Filed: Aug. 7, 2024

Related U.S. Application Data
(60) Provisional application No. 63/610,358, filed on Dec. 14, 2023.

(51) Int. Cl. H04W 28/02; H04W 72/12; H04W 84/12

(52) U.S. Cl. CPC H04W 28/0221; H04W 28/0278; H04W 72/12; H04W 84/12

(57) ABSTRACT

The present disclosure describes an access point or buddy device that augments Wi-Fi messages for backscatter devices. An apparatus includes a memory and a processor communicatively coupled to the memory. The processor generates a first message that includes a first portion that signals a first backscatter device that a second portion of the first message following the first portion is intended for the first backscatter device. The processor also transmits the first message.

### CROSS-REFERENCE TO RELATED APPLICATIONS

This application claims benefit of co-pending U.S. provisional patent application Ser. No. 63/610,358 filed Dec. 14, 2023. The aforementioned related patent application is herein incorporated by reference in its entirety.

### TECHNICAL FIELD

Embodiments presented in this disclosure generally relate to wireless (e.g., wireless fidelity (Wi-Fi)) communications. More specifically, embodiments disclosed herein relate to augmenting messages for backscatter devices.

### BACKGROUND

Backscatter devices use energy in wireless signals in the environment to power the functions and operations of the backscatter devices. Backscatter devices tend to be energy constrained and limited in processor and radio capabilities. In many instances, the backscatter devices may not be capable of generating and transmitting Wi-Fi frames on their own, limiting their communications capabilities.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIGS. 1A and 1B illustrate an example system.

FIG. 2 illustrates an example message in the system of FIG. 1A.

FIG. 3 illustrates an example message in the system of FIG. 1A.

FIG. 4 illustrates an example operation in the system of FIG. 1A.

FIG. 5 illustrates an example operation in the system of FIG. 1A.

FIG. 6 is a flowchart of an example method performed by the system of FIG. 1A.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

The present disclosure describes an access point or buddy device that augments Wi-Fi messages for backscatter devices. According to an embodiment, an apparatus includes a memory and a processor communicatively coupled to the memory. The processor generates a first message that includes a first portion that signals a first backscatter device that a second portion of the first message following the first portion is intended for the first backscatter device. The processor also transmits the first message.

According to another embodiment, a method includes generating a first message that includes a first portion that signals a first backscatter device that a second portion of the first message following the first portion is intended for the first backscatter device. The method also includes transmitting the first message.

According to another embodiment, a non-transitory computer readable medium stores instructions that, when executed by a processor, cause the processor to generate a first message that includes a first portion that signals a first backscatter device that a second portion of the first message following the first portion is intended for the first backscatter device. The instructions also cause the processor to transmit the first message.

### EXAMPLE EMBODIMENTS

The present disclosure describes an access point or buddy device that augments wireless messages (e.g., Wi-Fi messages) with sections that signal backscatter devices. Generally, the message may include a mid-amble and a backscatter device section following the mid-amble. The mid-amble may signal that the backscatter device section following the mid-amble is for a backscatter device. The backscatter device section may include a sequence of bits that the backscatter device may modulate to form a message. Alternatively or additionally, the backscatter device section may include silence during which the backscatter device may transmit a message. The mid-amble and backscatter section may be appended to a regular wireless message that includes sections intended for other devices.

In certain embodiments, the access point or buddy device provide several technical advantages. For example, by including the mid-amble in a message, the message may signal the backscatter device of when and how the backscatter device may transmit a message. As another example, by including the backscatter section in the message, the message may provide the backscatter device data that the backscatter device can modulate to form a message.

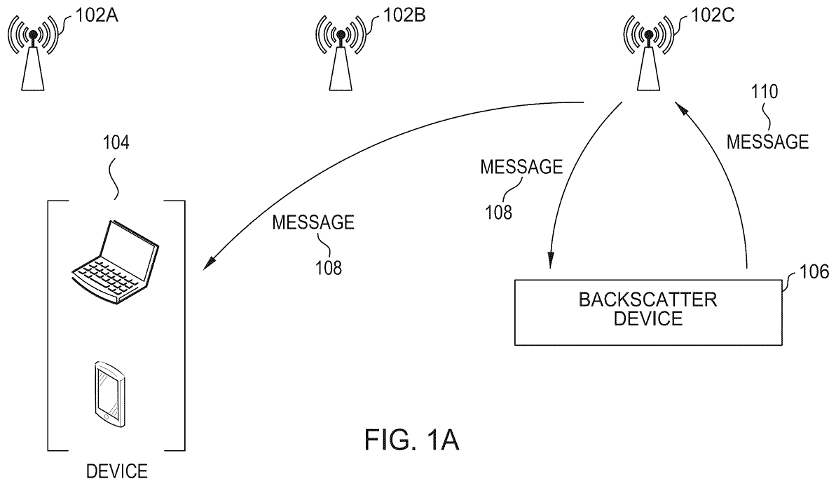

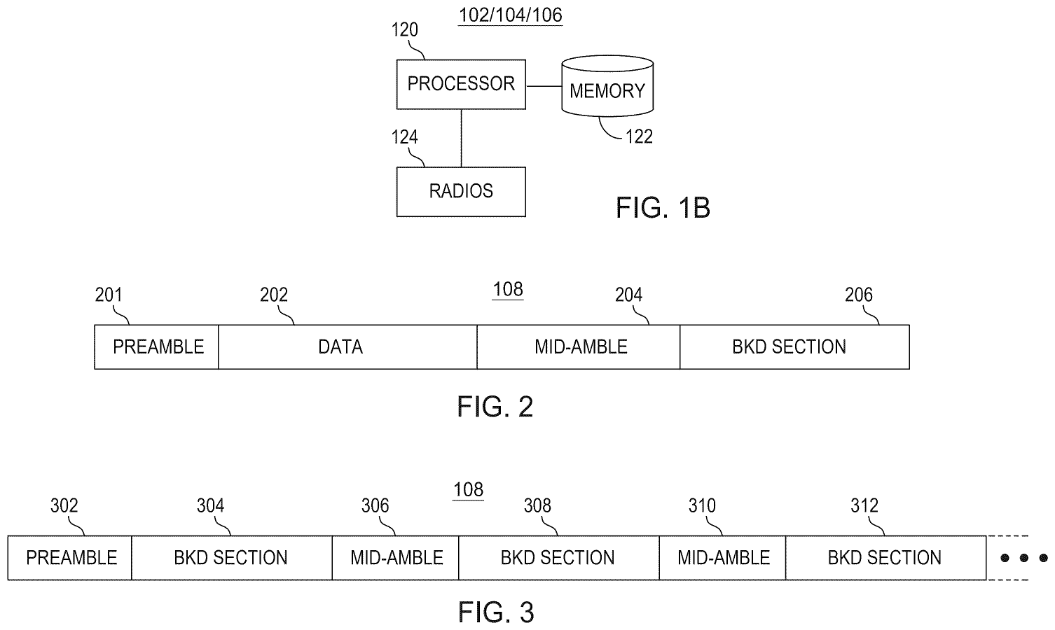

FIG. 1A illustrates an example system 100, which may be a wireless network (e.g., a Wi-Fi network). As seen in FIG. 1A, the system 100 includes one or more access points 102, one or more devices 104, and one or more backscatter devices 106. Generally, the devices 104 and backscatter devices 106 connect to an access point 102. The access point 102 provides network coverage for the system 100. The access point 102 communicates messages to the devices 104 and backscatter devices 106 and directs messages from the devices 104 and backscatter devices 106 towards their destination.

The access point 102 facilitates wireless communication (e.g., Wi-Fi communication) in the system 100. One or more devices 104 or backscatter devices 106 may connect to the access point 102. The access point 102 may then facilitate wireless communication for the connected devices 104 and backscatter devices 106. For example, the access point 102 may transmit messages to a connected device 104 or backscatter device 106. As another example, the access point 102 may receive messages transmitted by the device 104 or backscatter device 106. The access point 102 may then direct that message towards its intended destination. As seen in FIG. 1A, the system 100 includes the access points 102A, 102B, and 102C.

The device 104 may be any suitable device that wirelessly connects to the access point 102. As an example and not by way of limitation, the device 104 may be a computer, a laptop, a wireless or cellular telephone, an electronic notebook, a personal digital assistant, a tablet, or any other device capable of receiving, processing, storing, or communicating information with other components of the system 100. The device 104 may be a wearable device such as a virtual reality or augmented reality headset, a smart watch, or smart glasses. The device 104 may also include a user interface, such as a display, a microphone, keypad, or other appropriate terminal equipment usable by the user. The device 104 may include a hardware processor, memory, or circuitry configured to perform any of the functions or actions of the device 104 described herein. For example, a software application designed using software code may be stored in the memory and executed by the processor to perform the functions of the device 104.

The backscatter device 106 (which may also be referred to and function as an ambient power station or ambient power device) may be a device that relies on electrical energy in signals transmitted by the access point 102 to power the operations of the backscatter device 106. For example, the backscatter device 106 may receive wireless signals in the system 100 (e.g., signals transmitted by the access point 102). The backscatter device 106 then uses the energy in the signals to modify the signals with encoded data and to reflect the modified signals. The access point 102, device 104, and/or other backscatter devices 106 may then receive or detect the reflected signals with the encoded data. As another example, the backscatter device 106 may harvest and store energy (e.g., in a capacitor) from the signals transmitted by the access point 102. The backscatter device 106 may then use that energy to form and transmit messages or to perform other functions of the backscatter device 106.

As seen in FIG. 1A, the access point 102C transmits a message 108 to the device 104 and/or the backscatter device 106. The message 108 may include sections that are intended for the device 104 and sections that are intended for the backscatter device 106. For example, the message 108 may include a preamble that indicates which sections of the message 108 are intended for the device 104. Additionally, the message 108 may include another preamble (which may also be referred to as a mid-amble) following the sections intended for the device 104. The mid-amble may indicate the sections of the message 108 that are intended for the backscatter device 106.

The device 104 may receive the message 108 and use the information in the preamble to determine the sections of the message 108 that are intended for the device 104. The device 104 may then consume these sections of the message 108 and generate and transmit responses. The backscatter device 106 may receive the message 108 and use the information in the mid-amble to determine the sections of the message 108 that are intended for the backscatter device 106. The backscatter device 106 may then modulate the data in those sections to generate a message 110. The backscatter device 106 then transmits the message 110 to the access point 102C. In some embodiments, the sections of the message 108 intended for the backscatter device 106 include silence. When the backscatter device 106 determines that these sections include silence, the backscatter device 106 may understand that the backscatter device 106 is allowed to transmit during the silence. The backscatter device 106 then generates and transmits the message 110 during the silence.

The message 108 may include sections that are intended for any number of devices 104 and/or any number of backscatter devices 106. For example, the message 108 may include any number of mid-ambles that indicate sections of the message 108 that are intended for different backscatter devices 106. In some instances, the message 108 may include only sections that are intended for the backscatter devices 106, and not the devices 104. The message 108 may include a preamble that is actually a mid-amble indicating a section intended for a backscatter device 106. The message 108 may include other mid-ambles indicating sections that are intended for other backscatter devices 106.

In this manner, the access point 102C provides a message 108 that can signal devices 104 and/or backscatter devices 106. The message 108 may include sections that can be consumed by the devices 104 and sections that can be modulated by the backscatter device 106.

Although FIG. 1A shows the access point 102C transmitting the message 108 to the backscatter device 106, another device (e.g., another access point 102 and/or a device 104) may transmit the message 108 to the backscatter device 106. For example, the access point 102C may first transmit the message 108 to the other device, and then the other device may transmit the message 108 to the backscatter device 106. The other device may be referred to as a buddy device. In some instances, the buddy device may be used to transmit the message 108 based on the physical proximity of the buddy device to the backscatter device 106. For example, the device 104 may serve as the buddy device for the backscatter device 106 and transmit the message 108 to the backscatter device 106, because the device 104 is physically closer to the backscatter device 106 than to the access point 102C. The access point 102 may signal the buddy device (or any device in the system 100) to augment transmitted messages with sections intended for backscatter devices 106.

FIG. 1B illustrates an example access point 102, device 104, or backscatter device 106 in the system 100 of FIG. 1A. As seen in FIG. 1B, the access point 102, device 104, or backscatter device 106 includes a processor 120, a memory 122, and one or more radios 124.

The processor 120 is any electronic circuitry, including, but not limited to one or a combination of microprocessors, microcontrollers, application specific integrated circuits (ASIC), application specific instruction set processor (ASIP), and/or state machines, that communicatively couples to the memory 122 and controls the operation of the access point 102, device 104, and/or backscatter device 106. The processor 120 may be 8-bit, 16-bit, 32-bit, 64-bit or of any other suitable architecture. The processor 120 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 120 may include other hardware that operates software to control and process information. The processor 120 executes software stored on the memory 122 to perform any of the functions described herein. The processor 120 controls the operation and administration of the access point 102, device 104, and/or backscatter device 106 by processing information (e.g., information received from the memory 122 and radios 124). The processor 120 is not limited to a single processing device and may encompass multiple processing devices contained in the same device or computer or distributed across multiple devices or computers. The processor 120 is considered to perform a set of functions or actions if the multiple processing devices collectively perform the set of functions or actions, even if different processing devices perform different functions or actions in the set.

The memory 122 may store, either permanently or temporarily, data, operational software, or other information for the processor 120. The memory 122 may include any one or a combination of volatile or non-volatile local or remote devices suitable for storing information. For example, the memory 122 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 122, a disk, a CD, or a flash drive. In particular embodiments, the software may include an application executable by the processor 120 to perform one or more of the functions described herein. The memory 122 is not limited to a single memory and may encompass multiple memories contained in the same device or computer or distributed across multiple devices or computers. The memory 122 is considered to store a set of data, operational software, or information if the multiple memories collectively store the set of data, operational software, or information, even if different memories store different portions of the data, operational software, or information in the set.

The radios 124 may communicate messages or information using different communication technologies. For example, the access point 102, device 104, and/or backscatter device 106 may use one or more of the radios 124 for Wi-Fi communications. The access point 102, device 104, and/or backscatter device 106 may use one or more of the radios 124 to transmit messages and one or more of the radios 124 to receive messages. The access point 102, device 104, and/or backscatter device 106 may include any number of radios 124 to communicate using any number of communication technologies.

FIG. 2 illustrates an example message 108 in the system 100 of FIG. 1. Generally, the message 108 includes sections that are intended for a device 104 and sections that are intended for a backscatter device 106. As seen in FIG. 2, the message 108 includes a preamble 201, data 202, a mid-amble 204, and a backscatter device section 206. The preamble 201 is positioned at the beginning of the message 108. The data 202 follows the preamble 201. The mid-amble 204 follows the data 202, and the backscatter device section 206 follows the mid-amble 204. The message 108 may be expanded to include multiple mid-ambles and backscatter device sections to accommodate multiple backscatter devices 106. The mid-ambles may indicate different backscatter device sections that are intended for different backscatter devices 106.

The preamble 201 may include information about the data 202. For example, the preamble 201 may identify the portion of the message 108 that includes the data 202. Additionally, the preamble 201 may indicate that the data 202 is intended for the device 104 (e.g., by including an identifier or address of the device 104). As a result, the preamble 201 may signal the device 104 about the data 202. When the device 104 receives the message 108, the device 104 may use the information in the preamble 201 to determine where the data 202 is in the message 108. The device 104 may then process or consume the data 202 in the message 108 according to the information in the preamble 201.

The mid-amble 204 follows the data 202 in the message 108. Additionally, the backscatter device section 206 follows the mid-amble 204. For example, the mid-amble 204 may identify the portion of the message 108 that includes the backscatter device section 206. Additionally, the mid-amble 204 may indicate that the backscatter device section 206 is intended for the backscatter device 106 (e.g., by including an identifier or address of the backscatter device 106). As a result, the mid-amble 204 includes information that signals the backscatter device 106 about the backscatter device section 206 in the message 108. When the backscatter device 106 receives the message 108, the backscatter device 106 may examine the message 108 and look for the mid-amble 204. When the backscatter device 106 locates the mid-amble 204 (e.g., by detecting a predetermined or special sequence of bits that identify the mid-amble 204), the backscatter device 106 may use the information in the mid-amble 204 to determine the location of the backscatter device section 206 in the message 108. The backscatter device 106 may then use the information in the backscatter device section 206 to generate and transmit the message 110. For example, the backscatter device 106 may modulate the data in the backscatter device section 206 to form the message 110. As another example, if the backscatter device section 206 includes silence, the backscatter device 106 may generate and transmit the message 110 during the silence.

In some embodiments, the backscatter device section 206 includes a predetermined or a special sequence of bits or data that signal to the backscatter device 106 that the backscatter device 106 should modulate the sequence of bits or data to generate the message 110. When the backscatter device 106 examines the backscatter device section 206 and detects that sequence of bits or data, the backscatter device 106 may proceed to modulate the sequence of bits or data to generate the message 110. Additionally, the backscatter device section 206 may include verification bit(s) so that the backscatter device 106 (or any other device) can perform verification checks (e.g., cyclic redundancy checks or frame check sequence).

The access point 102 may determine the size of the backscatter device section 206 according to any criteria. For example, the access point 102 may determine the size of the backscatter device section 206 depending on the amount of data that the backscatter device 106 wants to transmit. The more data that the backscatter device 106 wants to transmit, the longer the backscatter device section 206. As another example, the access point 102 may determine the size of the backscatter device section 206 depending on the number of backscatter devices 106 that want to transmit. The more backscatter devices 106 that want to transmit, the shorter the backscatter device section 206 (although more backscatter device sections 206 may be added to accommodate multiple backscatter devices 106). As another example, the access point 102 may determine the size of the backscatter device section 206 according to the encoding ability of the backscatter device 106. Some encoding scheme may encode one bit by modulating or flipping multiple bits of the backscatter device section 206. If the backscatter device 106 uses such a scheme, then the backscatter device section 206 may be lengthened to accommodate the encoding scheme.

In this manner, the message 108 is augmented with information intended for the backscatter device 106. As a result, the message 108 may include information for the device 104 and the backscatter device 106. The preamble 201 and the mid-amble 204 signal the device 104 and/or the backscatter device 106 about the sections of the message 208 that are intended for the device 104 and the backscatter device 106.

In some embodiments, the access point 102 or buddy device transmits the message 108 as separate messages or frames. A first message or frame may include the preamble 201 and the data 202. The second message or frame may include the mid-amble 204 and the backscatter device section 206. The access point 102 may separate the first message or frame from the second message or frame with a short interframe space (or SIFS) so that the mid-amble 204 is more easily detectable.

FIG. 3 illustrates an example message 108 in the system 100 of FIG. 1A. Generally, FIG. 1A shows a message 108 that is intended for multiple different backscatter devices 106. As seen in FIG. 3, the message 108 includes a preamble 302, a backscatter device section 304, a mid-amble 306, a backscatter device section 308, a mid-amble 310, and a backscatter device section 312. The message 108 may include any number of mid-ambles and backscatter device sections. The preamble 302 is positioned at the beginning of the message 108. The backscatter device section 304 follows the preamble 302. The mid-amble 306 follows the backscatter device section 304. The backscatter device section 308 follows the mid-amble 306. The mid-amble 310 follows the backscatter device section 308. The backscatter device section 312 follows the mid-amble 310. Any number of mid-ambles and backscatter device sections may follow the backscatter device section 312. The mid-ambles in the message 108 may indicate a backscatter device section that is intended for different backscatter devices 106.

The message 108 in the example of FIG. 3 may include sections that are intended only for backscatter devices 106, rather than a device 104. Stated differently, none of the portions of the message 108 may be intended for a device 104. Rather, the portions of the message 108 are intended only for backscatter devices 106.

The preamble 302 may be similar to the mid-ambles in the message 108, and the preamble 302 may serve the same purpose as the mid-ambles in the message 108. As a result, the preamble 302 may be structured like a mid-amble. The preamble 302 may include information about the backscatter device section 304. For example, the preamble 302 may identify the portion of the message 108 that includes the backscatter device section 304. Additionally, the preamble 302 may indicate that the backscatter device section 304 is intended for a first backscatter device 106 (e.g., by including an identifier or address of the first backscatter device 106). As a result, the preamble 302 may signal the first backscatter device 106 about the backscatter device section 304. When the first backscatter device 106 receives the message 108, the first backscatter device 106 may use the information in the preamble 302 to locate the backscatter device section 304. The first backscatter device 106 may then use the information in the backscatter device section 304 to generate and transmit a message 110. For example, the first backscatter device 106 may modulate the data in the backscatter device section 304 to generate the message 110.

Other backscatter devices 106 may receive the message 108. Each of the mid-ambles 306, 310, etc. may include identifying information for one of the other backscatter devices 106. For example, each mid-amble 306, 310, etc. may identify a backscatter device 106 (e.g., by including an identifier or address of the backscatter device 106) and may indicate the location or position of a backscatter device section 308, 312, etc. in the message 108. When the backscatter device 106 receives the message 108 and determines the mid-amble 306, 310, etc. that includes the identifying information for the backscatter device 106, the backscatter device 106 may determine that the backscatter device section 308, 312, etc. following that mid-amble 306, 310, etc. is intended for the backscatter device 106. For example, the backscatter device 106 may determine that the mid-amble 306 includes the identifying information for the backscatter device 106. In response, the backscatter device 106 may determine that the backscatter device section 308 following the mid-amble 306 is intended for the backscatter device 106. The backscatter device 106 may then modulate the data in the backscatter device section 308 to generate a message 110. Another backscatter device 106 may similarly use the mid-amble 310 and the backscatter device section 312. In this manner, the message 108 may be augmented to accommodate any number of backscatter devices 106 in the system 100.

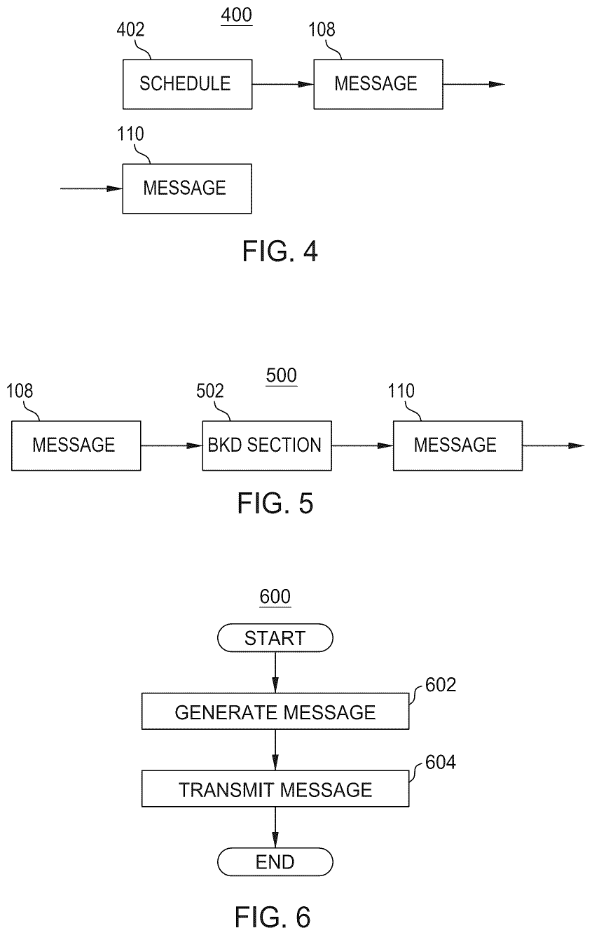

FIG. 4 illustrates an example operation 400 in the system 100 of FIG. 1A. Generally, the access point 102 performs the operation 400. By performing the operation 400, the access point 102 generates and transmits messages 108 for devices 104 and/or backscatter devices 106.

The access point 102 begins by determining a schedule 402 for transmissions. The access point 102 may determine the schedule 402 based on reports from the device 104 and/or the backscatter device 106. For example, the reports may be buffer status reports that indicate a number of messages or an amount of data awaiting transmission at the device 104 and/or the backscatter device 106. The access point 102 may then determine the schedule 402 that will accommodate or handle the awaiting messages or data. For example, the access point 102 may determine a schedule 402 that prioritizes transmissions from the device 104 or the backscatter device 106. As another example, the access point 102 may determine a schedule 402 that provides more transmission time for a device 104 or backscatter device 106 that has a significant amount of messages or data awaiting transmission. If a backscatter device 106 has no data awaiting transmission, then the schedule 402 may indicate that a mid-amble and backscatter device section for that backscatter device 106 may be omitted from the message 108.

The access point 102 then generates and transmits the message 108 according to the schedule 402. For example, the message 108 may include sections for the device 104 and the backscatter device 106. The portions of the message 108 that are intended for the backscatter device 106 may be signaled by a mid-amble. Additionally, the mid-amble may be followed by a backscatter device section in the message 108. The backscatter device section may include data that the backscatter device 106 may use to generate and transmit messages. For example, the backscatter device section may include data that the backscatter device 106 modulates to generate messages.

The backscatter device 106 may generate and transmit a message 110 to the access point 102. For example, the backscatter device 106 may modulate data in the backscatter device section to generate the message 110. As another example, the backscatter device 106 may generate and transmit the message 110 during silence included in the backscatter device section. The access point 102 receives the message 110 from the backscatter device 106. The access point 102 may then process or consume the information in the message 110. For example, the message 110 may include information about the environment that is sensed by the backscatter device 106. The access point 102 may then forward or direct the message 110 towards its destination (e.g., a server or a device).

FIG. 5 illustrates an example operation 500 in the system 100 of FIG. 1A. Generally, the backscatter device 106 performs the operation 500. By performing the operation 500, the backscatter device 106 generates and transmits the message 110.

The backscatter device 106 receives the message 108. The backscatter device 106 may receive the message 108 from an access point 102 or a buddy device (e.g., the device 104). The message 108 may include information that is intended for the backscatter device 106. That information may be signaled by a mid-amble positioned in the message 108. The mid-amble may be located in a portion of the message 108, other than the beginning or the end of the message 108. For example, the mid-amble may be positioned after a section in the message 108 that is intended for a device 104. The mid-amble may include information that identifies a backscatter device section 502 in the message 108. The backscatter device section 502 may follow the mid-amble. The mid-amble may also include identifying information for the backscatter device 106. When the backscatter device 106 determines that the mid-amble includes identifying information for the backscatter device 106, the backscatter device 106 may determine that the backscatter device section 502 is intended for the backscatter device 106.

The backscatter device 106 then processes the backscatter device section 502. For example, the backscatter device 106 may modulate the data or information in the backscatter device section 502 to generate a message 510. The backscatter device section 502 may include a predetermined or special sequence of data or bits that the backscatter device 106 uses for modulation. The backscatter device 106 modulates the sequence of data or bits to generate the message 510. The backscatter device 106 then transmits the message 510 back to the access point 102 or the buddy device. As another example, the backscatter device section 502 may include silence. The backscatter device 106 may understand that the silence indicates that the backscatter device 106 may generate and transmit the message 110 during the silence. In response, the backscatter device 106 generates and transmits the message 110 during the silence back to the access point 102 or the buddy device.

FIG. 6 is a flowchart of an example method 600 performed by the system 100 of FIG. 1A. In particular embodiments, the access point 102 or a buddy device performs the method 600. By performing the method 600, the access point 102 or the buddy device generates and transmits a message 108.

In block 602, the access point 102 or the buddy device generates the message 108. The message 108 may include a section intended for a device 104. This section may begin with a preamble that indicates a data section following the preamble. When a device 104 process the preamble, the device 104 may determine that the data section is intended for the device 104. Additionally, the message 108 may include a mid-amble following the data section and a backscatter device section following the mid-amble. The mid-amble may include information that signals a backscatter device 106 that the backscatter device section is intended for the backscatter device 106. When the backscatter device 106 processes the mid-amble, the backscatter device 106 may determine that the backscatter device section is intended for the backscatter device 106.

In block 604, the access point 102 or buddy device transmits the message 108. The access point 102 or buddy device may transmit the message 108 to one or more devices 104 and to one or more backscatter devices 106. The devices 104 and the backscatter devices 106 may then process the message 108. The backscatter devices 106 may generate and transmit messages 110 back to the access point 102 or the buddy device using the information in the message 108. For example, a backscatter device 106 may modulate the data in the backscatter device section to generate the message 110. The backscatter device 106 may then transmit the message 110 back to the access point 102 or buddy device. As another example, the backscatter device 106 may generate the message 110 in response to determining that the backscatter device section includes silence. The backscatter device 106 may transmit the message 110 during the silence to the access point 102 or the buddy device.

In summary, the access point 102 or buddy device augments wireless messages (e.g., Wi-Fi messages) with sections that signal backscatter devices 106. Generally, the message 108 may include a mid-amble and a backscatter device section following the mid-amble. The mid-amble may signal that the backscatter device section following the mid-amble is for a backscatter device 106. The backscatter device section may include a sequence of bits that the backscatter device 106 may modulate to form a message 110. Alternatively or additionally, the backscatter device section may include silence during which the backscatter device 106 may transmit a message 110. The mid-amble and backscatter device section may be appended to a regular wireless message 108 that includes sections intended for other devices 104.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. An apparatus comprising:
a memory; and
a processor communicatively coupled to the memory, the processor configured to:
generate a first message comprising a first portion that signals a first backscatter device that a second portion of the first message following the first portion is intended for the first backscatter device; and
transmit the first message.

2. The apparatus of claim 1, wherein the second portion comprises silence and wherein the first portion signals to the first backscatter device that the first backscatter device is allowed to transmit a message during the silence.

3. The apparatus of claim 1, wherein the second portion comprises a plurality of bits and wherein the first portion signals to the first backscatter device that the first backscatter device is allowed to modulate the plurality of bits with data.

4. The apparatus of claim 1, wherein the first portion is a preamble of the first message.

5. The apparatus of claim 1, wherein the processor is further configured to transmit a second message prior to transmitting the first message and wherein the first message is separated from the second message by a short interframe space.

6. The apparatus of claim 1, wherein the first message further comprises a third portion that signals a second backscatter device different from the first backscatter device that a fourth portion of the first message is intended for the second backscatter device.

7. The apparatus of claim 1, wherein the processor is further configured to generate a schedule for transmissions of the first backscatter device based on a buffer status report from the first backscatter device and wherein the first message is generated based on the schedule.

8. A method comprising:
generating a first message comprising a first portion that signals a first backscatter device that a second portion of the first message following the first portion is intended for the first backscatter device; and
transmitting the first message.

9. The method of claim 8, wherein the second portion comprises silence and wherein the first portion signals to the first backscatter device that the first backscatter device is allowed to transmit a message during the silence.

10. The method of claim 8, wherein the second portion comprises a plurality of bits and wherein the first portion signals to the first backscatter device that the first backscatter device is allowed to modulate the plurality of bits with data.

11. The method of claim 8, wherein the first portion is a preamble of the first message.

12. The method of claim 8, further comprising transmitting a second message prior to transmitting the first message and wherein the first message is separated from the second message by a short interframe space.

13. The method of claim 8, wherein the first message further comprises a third portion that signals a second backscatter device different from the first backscatter device that a fourth portion of the first message is intended for the second backscatter device.

14. The method of claim 8, further comprising generating a schedule for transmissions of the first backscatter device based on a buffer status report from the first backscatter device and wherein the first message is generated based on the schedule.

15. A non-transitory computer readable medium storing instructions that, when executed by a processor, cause the processor to:
generate a first message comprising a first portion that signals a first backscatter device that a second portion of the first message following the first portion is intended for the first backscatter device; and
transmit the first message.

16. The medium of claim 15, wherein the second portion comprises silence and wherein the first portion signals to the first backscatter device that the first backscatter device is allowed to transmit a message during the silence.

17. The medium of claim 15, wherein the second portion comprises a plurality of bits and wherein the first portion signals to the first backscatter device that the first backscatter device is allowed to modulate the plurality of bits with data.

18. The medium of claim 15, wherein the first portion is a preamble of the first message.

19. The medium of claim 15, wherein the instructions further cause the processor to transmit a second message prior to transmitting the first message and wherein the first message is separated from the second message by a short interframe space.

20. The medium of claim 15, wherein the first message further comprises a third portion that signals a second backscatter device different from the first backscatter device that a fourth portion of the first message is intended for the second backscatter device.
